(19) United States
(12) Patent Application Publication
(10) Pub. No.: US 2026/0147516 A1
(43) Pub. Date: May 28, 2026

(54) Photograph Album Device

(71) Applicant: Patricka Hagans, Columbia, SC (US)

(72) Inventor: Patricka Hagans, Columbia, SC (US)

(21) Appl. No.: 18/962,805

(22) Filed: Nov. 27, 2024

(51) Int. Cl. G06F 3/14; G06T 11/20

(52) U.S. Cl. CPC G06F 3/14; G06T 11/20

(57) ABSTRACT

A photograph album device includes a photo album and a plurality of original photographs stored on a respective page of a plurality of pages in the photo album. Each original photograph of the plurality of original photographs can be viewed by a user when the user opens the photo album. A plurality of answer keys is provided and each answer key of the plurality of answer keys has image indicia applied to each answer key of the plurality of answer keys. The image indicia on a respective answer key of the plurality of answer keys corresponds to a respective original photograph of the plurality of original photographs. Furthermore, the image indicia on the respective answer key enables the user to interpret a hidden message on the respective original photograph when the user views the respective original photograph in conjunction with the respective answer key.

### (B) CROSS-REFERENCE TO RELATED APPLICATIONS

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to photograph devices and more particularly pertains to a new photograph device for enabling a user to interpret an inherent but hidden image in a photograph. The device includes a plurality of original photographs which is each stored in a photo album. The device includes a plurality of photograph copies which comprise copies of each of the original photographs. Image indicia are hand-drawn onto each of the plurality of photograph copies to highlight inherent but hidden imagery on each of the plurality of photograph copies. Each original photograph is viewed in the photo album in conjunction with an associated photograph copy to enable a user to interpret the inherent but hidden imagery in the original photograph.

### (2) Description of Related Art Including Information Disclosed Under 37 CFR 1.97 and 1.98

The prior art relates to photograph devices including: a game card device comprising a game card that has a front part and a rear part that has a migrating ink pattern which obscures an image on the front part; a children's amusement device that includes a translucent sheet that has hidden images that can be revealed when the translucent sheet is illuminated with back lighting; an online community involving digital imagery that is embedded into photographs to reveal a hidden message in the photographs; a method of playing a game which includes providing a game sheet that has a first substrate with an imprinted hidden image and a second substrate that has an activation medium for revealing the imprinted hidden image on the first substrate; a coloring device that includes a substrate having resist zones located adjacent to non-resist zones which cooperate to define a hidden message. In no instance does the prior art disclose a photograph album device that includes a photo album and a plurality of original photographs which are each stored in the photo album and a plurality of answer keys which each corresponds to a respective original photograph and hand-drawn image indica on each answer key to highlight an inherent but hidden image on the answer key to enable a user to subsequently interpret the inherent but hidden image on the corresponding original photograph.

### (H) BRIEF SUMMARY OF THE INVENTION

An embodiment of the disclosure meets the needs presented above by generally comprising a photo album and a plurality of original photographs stored on a respective page of a plurality of pages in the photo album. Each original photograph of the plurality of original photographs can be viewed by a user when the user opens the photo album. A plurality of answer keys is provided and each answer key of the plurality of answer keys has image indicia applied to each answer key of the plurality of answer keys. The image indicia on a respective answer key of the plurality of answer keys corresponds to a respective original photograph of the plurality of original photographs. Furthermore, the image indicia on the respective answer key enables the user to interpret a hidden message on the respective original photograph when the user views the respective original photograph in conjunction with the respective answer key.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a photograph album device according to an embodiment of the disclosure.

FIG. 2 is a perspective view of an embodiment of the disclosure showing a first original photograph being displayed in a photo album.

FIG. 3 is a perspective view of an embodiment of the disclosure showing a second original photograph being displayed in a photo album.

FIG. 4 is a perspective view of an embodiment of the disclosure showing a hidden image on a first original photograph being inferred by comparison to a first answer key.

FIG. 5 is a perspective view of an embodiment of the disclosure showing a hidden image on a second original photograph being inferred by comparison to a second answer key.

FIG. 6 is a perspective in-use view of an embodiment of the disclosure.

FIG. 7 is a perspective view of an alternative embodiment of the disclosure.

### (J) DETAILED DESCRIPTION OF THE INVENTION

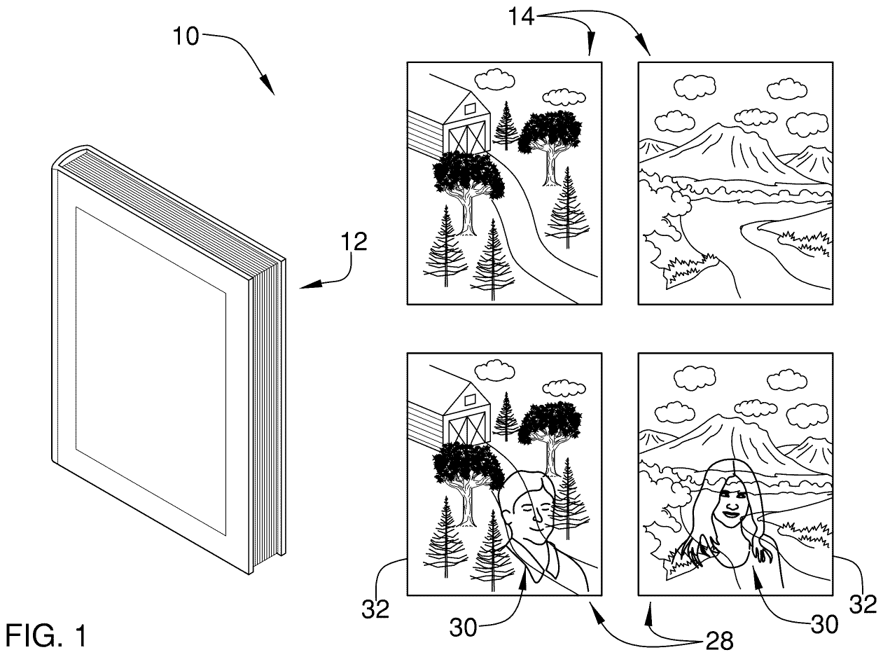

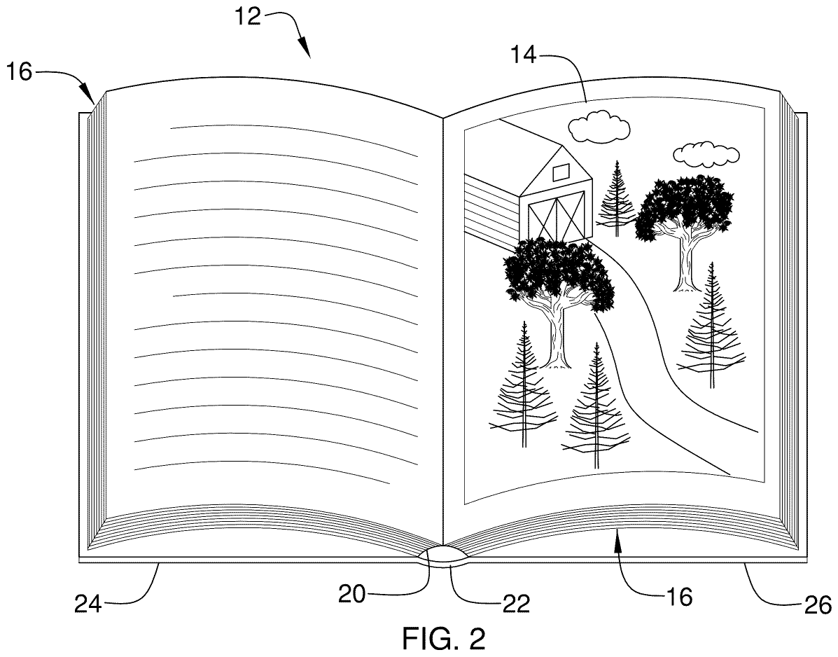

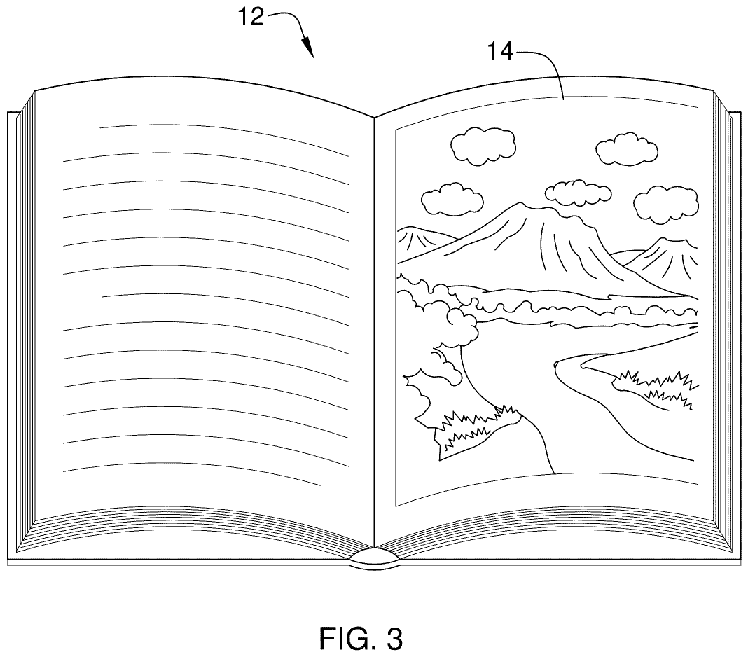

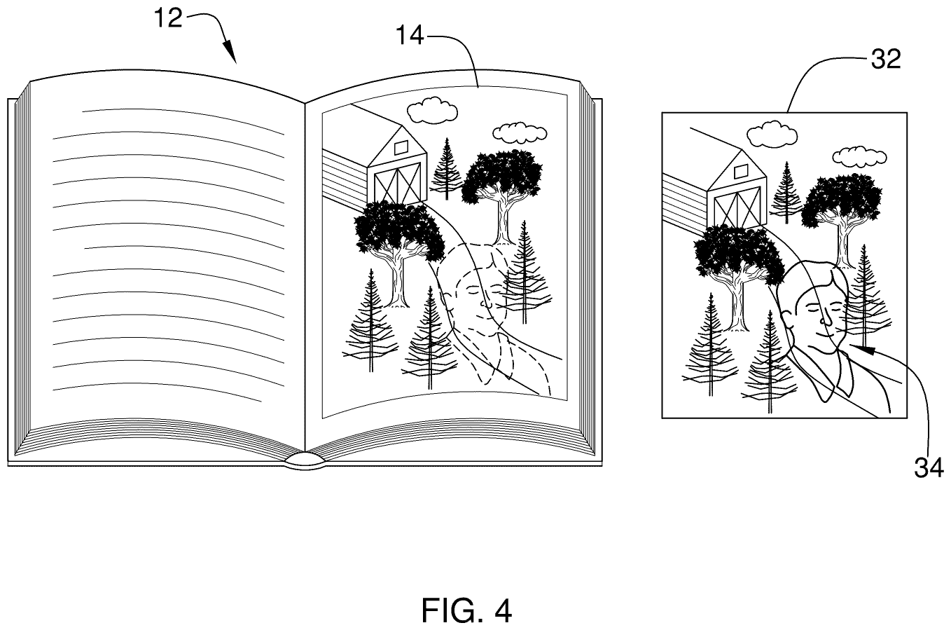

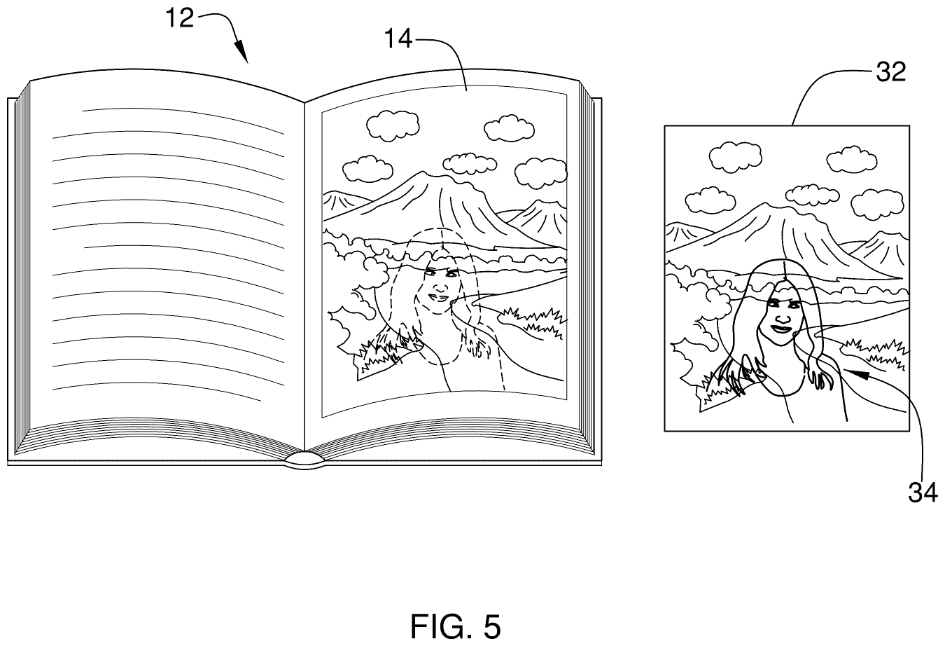

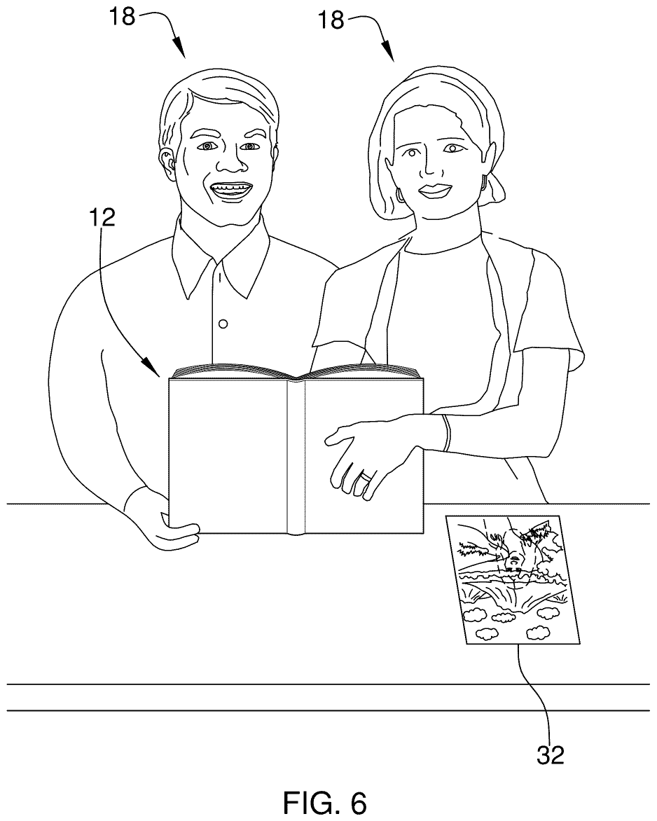

With reference now to the drawings, and in particular to FIGS. 1 through 7 thereof, a new photograph device embodying the principles and concepts of an embodiment of the disclosure and generally designated by the reference numeral 10 will be described.

As best illustrated in FIGS. 1 through 7, the photograph album device 10 generally comprises a photo album 12 and a plurality of original photographs 14. Each original photograph 14 of the plurality of original photographs 14 is stored on a respective page 16 of a plurality of pages 16 in the photo album 12. Additionally, each original photograph 14 of the plurality of original photographs 14 can be viewed by a user 18 when the user 18 opens the photo album 12. Each original photograph 14 of the plurality of original photographs 14 may be a printed photograph of any conventional design that was captured with a camera of any conventional design, including but not being limited to digital cameras or analog cameras. Each page 16 of the plurality of pages 16 in the photo album 12 has a coupled edge 20 which is coupled to a binding 22 of the photo album 12 that extends between each of a front cover 24 and a back cover 26 of the photo album 12. The front cover 24 and the back cover 26 are oriented to be coplanar with each other when the front cover 24 and the back cover 26 are positioned in an open position. Subsequently the user 18 is enabled to view the original photograph 14 that is stored on each respective page 16 of the plurality of pages 16 when the user 18 turns each page 16 of the plurality of pages 16. Furthermore, the photo album 12 may be a photo album of any conventional size or design.

A plurality of answer keys 28 is provided and each answer key 28 of the plurality of answer keys 28 has image indicia 30 which are applied to each answer key 28 of the plurality of answer keys 28. The image indicia 30 on a respective answer key 28 of the plurality of answer keys 28 corresponds to a respective original photograph 14 of the plurality of original photographs 14. Furthermore, the image indicia 30 on the respective answer key 28 enables the user 18 to interpret a hidden message on the respective original photograph 14 when the user 18 views the respective original photograph 14 in conjunction with the respective answer key 28. The user 18 can then enjoy the experience of viewing respective original photograph 14 and interpreting the hidden message on the respective original photograph 14.

The plurality of answer keys 28 comprises a plurality of photograph copies 32 and each photograph copy 32 of the plurality of photograph copies 32 comprises a copy of a respective original photograph 14 of the plurality of original photographs 14. The image indicia 30 on each photograph copy 32 of the plurality of photograph copies 32 comprises hand-drawn markings 34, created by the user 18, which are strategically positioned to illustrate an inherent but hidden image in each photograph copy 32 of the plurality of photograph copies 32 which corresponds to the respective original photograph 14. For example, as is shown in FIG. 1, a face of a person that is implied by the arrangement of leaves of a tree can be highlighted by the hand-drawn markings 34 to draw attention to the face of the person. The image indicia 30 on each photograph copy 32 of the plurality of photograph copies 32 enables the user 18 to interpret the inherent but hidden image in the respective original photograph 14 when the user 18 views the respective original photograph 14.

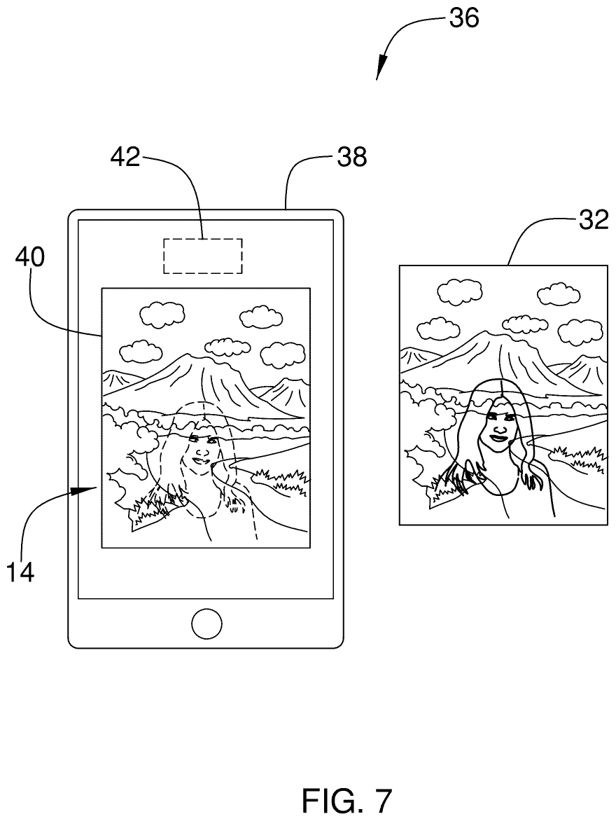

In an alternative embodiment 36 as shown in FIG. 7, a personal electronic device 38 is provided which includes a display 40 and an electronic memory 42. The electronic memory 42 stores a database comprising the plurality of original photographs 14. The electronic memory 42 is in electrical communication with the display 40 thereby enabling the display 40 to display each of the plurality of original photographs 14 stored in the electronic memory 42. Furthermore, the display 40 enables the user 18 to view each original photograph 14 of the plurality of original photographs 14 on the display 40. The personal electronic device 38 may comprise an electronic tablet, a smartphone or other type of electronic device that is typically employed for viewing digital imagery.

In use, the user 18 captures the original photographs 14 of the typical things that are commonly photographed, including but not being limited to, geological features or plant life or architecture. The plurality of photograph copies 32 are produced and each of the original photographs 14 is stored in the photo album 12 to enable the user 18 to view the original photographs 14 in the photo album 12. The hand-drawn markings 34 are drawn on each of the photograph copies 32 to highlight the inherent but hidden image on each of the photograph copies 32. The user 18 views each original photograph 14 in the photo album 12 in conjunction with the photograph copy 32 that corresponds to the original photograph 14. The hand-drawn markings 34 on the photograph copy 32 that corresponds to the original photograph 14 enables the user 18 to interpret the inherent but hidden image in the corresponding original photograph 14. Furthermore, the unmodified original photograph 14 enables the user 18 to enjoy the original photograph 14 without interpreting the inherent but hidden message if they chose to do so.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A photograph album device for enabling a user to interpret hidden messages within an image, said device comprising:
a photo album;
a plurality of original photographs, each original photograph of said plurality of original photographs being stored on a respective page of a plurality of pages in said photo album wherein each original photograph of said plurality of original photographs is configured to be viewed by the user when the user opens said photo album; and
a plurality of answer keys, each answer key of said plurality of answer keys having image indicia being applied to each answer key of said plurality of answer keys, said image indicia on a respective answer key of said plurality of answer keys corresponding to a respective original photograph of said plurality of original photographs wherein said image indicia on said respective answer key is configured to enable the user to interpret a hidden message on said respective original photograph when the user views said respective original photograph in conjunction with said respective answer key.

2. The photograph album device according to claim 1, wherein:
each page of said plurality of pages in said photo album has a coupled edge being coupled to a binding of said photo album which extends between each of a front cover and a back cover of said photo album; and
said front cover and said back cover is oriented to be coplanar with each other when said front cover and said back cover are positioned in an open position wherein said photo album is configured to enable the user to view said original photograph that is stored on each respective page of said plurality of pages when the user turns each page of said plurality of pages.

3. The photograph album device according to claim 1, wherein said plurality of answer keys comprises a plurality of photograph copies.

4. The photograph album device according to claim 3, wherein each photograph copy of said plurality of photograph copies comprises a copy of a respective original photograph of said plurality of original photographs.

5. The photograph album device according to claim 4, wherein said image indicia on each photograph copy of said plurality of photograph copies comprises hand-drawn markings which are strategically positioned to illustrate an inherent but hidden image in each photograph copy of said plurality of photograph copies which corresponds to said respective original photograph wherein said image indicia on each photograph copy of said plurality of photograph copies is configured to enable the user to interpret said inherent but hidden image in said respective original photograph when the user views said respective original photograph.

6. A photograph album device for enabling a user to interpret hidden messages within an image, said device comprising:
a photo album;
a plurality of original photographs, each original photograph of said plurality of original photographs being stored on a respective page of a plurality of pages in said photo album wherein each original photograph of said plurality of original photographs is configured to be viewed by the user when the user opens said photo album, each page of said plurality of pages in said photo album having a coupled edge being coupled to a binding of said photo album which extends between each of a front cover and a back cover of said photo album, said front cover and said back cover being oriented to be coplanar with each other when said front cover and said back cover are positioned in an open position wherein said photo album is configured to enable the user to view said original photograph that is stored on each respective page of said plurality of pages when the user turns each page of said plurality of pages; and
a plurality of answer keys, each answer key of said plurality of answer keys having image indicia being applied to each answer key of said plurality of answer keys, said image indicia on a respective answer key of said plurality of answer keys corresponding to a respective original photograph of said plurality of original photographs wherein said image indicia on said respective answer key is configured to enable the user to interpret a hidden message on said respective original photograph when the user views said respective original photograph in conjunction with said respective answer key, said plurality of answer keys comprising a plurality of photograph copies, each photograph copy of said plurality of photograph copies comprising a copy of a respective original photograph of said plurality of original photographs, said image indicia on each photograph copy of said plurality of photograph copies comprising hand-drawn markings which are strategically positioned to illustrate an inherent but hidden image in each photograph copy of said plurality of photograph copies which corresponds to said respective original photograph wherein said image indicia on each photograph copy of said plurality of photograph copies is configured to enable the user to interpret said inherent but hidden image in said respective original photograph when the user views said respective original photograph.

8. The photograph album device according to claim 7, further comprising a personal electronic device which includes a display and an electronic memory.

9. The photograph album device according to claim 8, wherein:
said electronic memory stores a database comprising said plurality of original photographs; and
said electronic memory is in electrical communication with said display thereby enabling said display to display each of said plurality of original photographs stored in said electronic memory wherein said display is configured to enable the user to view each original photograph of said plurality of original photographs on said display.

10. A method of interpreting an inherent but hidden image in a photograph, the steps of the method comprising:
capturing a plurality of original photographs with a camera;
making a copy of each original photograph of said plurality of original photographs to produce a plurality of photograph copies;
storing each original photograph of said plurality of photographs in a photo album;
drawing hand-drawn markings on each photograph copy of said plurality of photograph copies to highlight an inherent but hidden image in each photograph copy of said plurality of photograph copies; and
viewing each original photograph of said plurality of original photographs in said photo album in conjunction with a respective photograph copy of said plurality of photograph copies which corresponds to a respective original photograph of said plurality of original photographs wherein said hand drawn marking on said respective photograph copy is configured to enable a user to interpret said inherent but hidden image in said respective original photograph when the user views said respective original photograph.
